(19) United States
(12) Patent Application Publication
(10) Pub. No.: US 2007/0066696 A1
(43) Pub. Date: Mar. 22, 2007

(54) Process for producing crosslinked foam of polyolefin-based resin

(75) Inventors: Katsuhiro Yamada, Ichihara-shi (JP); Yasuro Suzuki, Kisaradu-shi (JP)

Correspondence Address: FITCH, EVEN, TABIN & FLANNERY, P. O. BOX 18415, WASHINGTON, DC, 20036, US

(73) Assignee: Sumitomo Chemical Company, Limited, Tokyo (JP)

(21) Appl. No.: 11/523,011

(22) Filed: Sep. 19, 2006

(30) Foreign Application Priority Data
Sep. 21, 2005 (JP) 2005-273387

(51) Int. Cl. C08J 9/00; C08J 9/10

(52) U.S. Cl. 521/92

(57) ABSTRACT

A process for producing a crosslinked foam of a polyolefin-based resin by a pressure-foaming method, which comprises heating a polyolefin-based resin composition containing the polyolefin-based resin, a crosslinking agent and foaming agent under pressure using a mold in which a metal charge is charged inside the mold.

### TECHNICAL FIELD

The present invention relates to a process for producing, a crosslinked foam of a polyolefin-based resin.

### BACKGROUND ART

Crosslinked foams of polyolefin-based resins such as high-pressure low density polyethylene, ethylene-vinyl acetate copolymer and the like are used for various kinds of goods as an insulating material, cushioning material and the like. As a producing method of the crosslinked foam, a pressure foaming method is common, for example, it is known that a method of obtaining the foam, which contains filling crosslinkable and foamable polyolefin-based resin composition composed of high-pressure low density polyethylene, a foaming agent and a crosslinking agent in a mold, heating it under pressure for a given period of time to decompose the foaming agent and the crosslinking agent, and then allowing a foam to fling out of the mold by decreasing the pressure to obtain the foam (e.g. JP61-266441 A).

In the production of a crosslinked foam, a crosslinkable and foamable polyolefin-based resin composition obtained by changing a kind of an olefin-based resin or kinds and concentrations of a foaming agent and a crosslinking agent depending on properties required in the crosslinked foam to be produced, is used as a raw material.

In the production of a crosslinked foam according to a conventional pressure foaming process, dimensions (thickness, longitudinal, transversal) of a crosslinked foam to be obtained may be varied depending on the crosslinkable and foamable polyolefin-based resin composition, therefore, for example, when a foam which had a larger dimension than a desired dimension, was obtained, the extra part was cut down, or various molds were prepared corresponding to various crosslinkable and foamable polyolefin-based resin compositions used as raw materials, respectively, and the mold was often changed depending on the resin composition used in molding. Therefore, these methods were not sufficiently satisfied economically.

### DISCLOSURE OF THE INVENTION

Under such situations, a subject to be solved by the present invention is to provide a process for producing a crosslinked foam of a polyolefin-based resin by a pressure forming method which is excellent in economic efficiency.

That is, the present invention relates to a process for producing a crosslinked foam of a polyolefin-based resin by a pressure foaming method, wherein the process comprises heating a polyolefin-based resin composition containing a polyolefin-based resin, a foaming agent and a crosslinking agent under pressure using a mold in which a metal charge is charged inside the mold.

### BEST MODE FOR CARRYING OUT THE INVENTION

As a polyolefin-based resin used in the present invention, polyethylene-based resins, polypropylene-based resins, polybutene-based resins and the like are listed. Among these, polyethylene-based resins, in other words, resins composed of a polymer in which a content of monomer units based on ethylene is not less than 50% by weight are preferable, as the polyethylene-based resins, ethylene-a-olefin copolymers, ethylene-unsaturated ester copolymers, high-pressure low density polyethylene and the like can be used, and these are used alone or in combination of two or more.

As the ethylene-a-olefin copolymers, polymers containing monomer units based on ethylene and monomer units based on an a-olefin having 3 to 20 carbon atoms, for example, there can be used an ethylene-1-butene copolymer, ethylene-4-methyl-1-pentene copolymer, ethylene-1-hexene copolymer, ethylene-1-octene copolymer, ethylene-1-decene copolymer, ethylene-1-butene-4-methyl-1-pentene copolymer, ethylene-1-butene-1-hexene copolymer, ethylene-1-butene-1-octene copolymer and the like, preferably, from the view point of heightening strength of a crosslinked foam, an ethylene-1-butene copolymer, ethylene-1-hexene copolymer, ethylene-1-butene-1-hexene copolymer and ethylene-1-octene copolymer, and more preferably an ethylene-1-butene-1-hexene copolymer, ethylene-1-hexene copolymer and ethylene-1-octene copolymer.

The ethylene-unsaturated ester-based copolymer is a polymer having monomer units based on ethylene and monomer units based on the unsaturated ester. The unsaturated ester includes vinyl esters of carboxylic acids such as vinyl acetate and vinyl propionate, and alkyl esters of unsaturated carboxylic acids such as methyl acrylate, ethyl acrylate, n-propyl acrylate, isopropyl acrylate, n-butyl acrylate, t-butyl acrylate, isobutyl acrylate, methyl methacrylate, ethyl methacrylate, n-propyl methacrylate, isopropyl methacrylate, n-butyl methacrylate, t-butyl methacrylate and isobutyl methacrylate.

As the ethylene-unsaturated ester copolymer, there can be listed a copolymer having monomer units based on ethylene and monomer units based on at least one unsaturated ester selected from vinyl esters of carboxylic acids and alkyl esters of unsaturated carboxylic acids such as an ethylene-vinyl acetate copolymer, ethylene-methyl acrylate copolymer, ethylene-ethyl acrylate copolymer, ethylene-methyl acrylate-ethyl acrylate copolymer, ethylene-methyl methacrylate copolymer and ethylene-ethyl methacrylate copolymer, preferably an ethylene-vinyl acetate copolymer, ethylene-methyl acrylate copolymer, ethylene-ethyl acrylate copolymer and ethylene-methyl methacrylate copolymer.

High-pressure low density polyethylene is a polymer obtained by polymerizing ethylene under polymerization conditions of a polymerization pressure of 1000 to 4000 kg/cm² and a polymerization temperature of 200 to 300 in the presence of a radical generator using a vessel-type polymerization reactor or tubular-type polymerization reactor.

The density of the polyolefin-based copolymer resin is usually 880 to 960 kg/cm³, and from the view point of enhancement of lightness of the crosslinked foam, preferably 940 g/cm3 or lower, more preferably 930 kg/m³ or lower, most preferably 925 kg/m³ or lower. The density is measured by an underwater substitution method described in JIS K7112-1980 after performing annealing described in JIS K6760-1995.

A melt flow rate (MFR) of the polyolefin-based copolymer resin is usually 0.01 to 20 g/10 minutes. The MFR is preferably 0.05 g/10 minutes or more from the viewpoint of enhancement of lightness through heightening of forming magnification, more preferably 0.1 g/10 minutes. In addition, from the viewpoint of enhancement of strength of the crosslinked foam, the MFR is preferably 10 g/10 minutes or less, more preferably 8 g/10 minutes or less, further preferably 5 g/10 minutes or less. The MFR is measured by A method under conditions of a temperature of 190° C. and a load of 21.18 N according to JIS K7210-1995.

As a cross-linking agent used in the present invention, organic peroxides are suitably used, for example, dicumyl peroxide, 1,1-di-tertiary butyl peroxy-3,3,5-trimethylcyclohexane, 2,5-dimethyl-2,5-di-tertiary butyl peroxyhexane, 2,5-dimethyl-2,5-di-tertiary butyl peroxyhexine, a,a-di-tertiary butyl peroxy isopropylbenzene, tertiary butyl peroxyketone and tertiary butyl peroxy benzoate are illustrated. As these organic peroxides, organic peroxides having a decomposition temperature of a fluidization temperature of the polyolefin-based resin or higher are suitably used.

As the foaming agent used in the present invention, thermal decomposition type foaming agents are preferably used. For example, there can be listed sodium hydrogen carbonate, azodicarbonamide, barium azodicarboxylate, azobisbutyronitrile, nitrodiguanidine, N,N-dinitrosopentamethylenetetramine, N,N′-dimethyl-N,N′-dinitrosoterephthalamide, P-toluenesulfonyl hydrazide, P,P′-oxybis(benzenesulfonyl hydrazide), azobisisobutyronitrile, P,P′-oxybisbenzenesulfonyl semicarbazide, 5-phenyltetrazole, trihydrazinotriazine, and hidrazodicarbonamide, and these are used alone or a combination of two kinds or more.

As these foaming agents, thermal decomposition type foaming agents having a decomposition temperature of a melting temperature of the polyolefin-based resin used or higher are suitably used, and sodium hydrogen carbonate and azodicarbonamide are commonly used.

The polyolefin-based resin composition used for the production process of the crosslinked foam of the olefin-based resin is a resin composition containing an olefin-based resin, a crosslinking agent and a foaming agent. The compounding ratios of the crosslinking agent and the foaming agent can be properly determined depending on physical properties (specific gravity, rigidity, strength, etc.) of a crosslinked foam and the ratio of the crosslinking agent is generally 0.7 to 1.3 parts by weight, preferably 0.9 to 1.2 parts by weight per 100 parts by weight of the polyolefin-based resin, and the ratio of the foaming agent is generally 1 to 50 parts by weight, preferably 1 to 15 parts by weight per 100 parts by weight of the polyolefin-based resin.

A foaming auxiliary may be optionally added to the above-described polyolefin-based resin composition. The foaming auxiliary includes compounds containing mainly urea; metal oxides such as zinc oxide and lead oxide; higher fatty acids such as salicylic acid and stearic acid; metal compounds of the higher fatty acids; and the like.

The used amount of the foaming auxiliary is preferably 0.1 to 30% by weight, more preferably 1 to 20% by weight based on the total amount of the foaming agent and foaming auxiliary of 100% by weight.

Further, in the above-mentioned polyolefin-based resin composition, various additives such as cross-linking auxiliaries, heat stabilizers, weathering agents, lubricants, antistatic agents, and fillers and pigments (metal oxides such as zinc oxide, titanium oxide, calcium oxide, magnesium oxide and silicon oxide; carbonates such as calcium carbonate; fibrous materials such pulp; and the like) may be compounded, if necessary.

A method of producing the polyolefin-based resin composition includes known kneading methods, for example, a method of kneading a polyolefin-based resin, a crosslinking agent and a foaming agent at a temperature lower than decomposition temperatures of the crosslinking agent and the foaming agent with a mixing roll, a kneader, an extruder or the like.

Production of the crosslinked foam of the polyolefin-based resin of the present invention is carried out by a pressure foaming method, and a pressure-one step foaming method or a pressure-two steps foaming method is mainly used.

In the pressure-one step foaming method, the crosslinked foam is produced by (1) filling a polyolefin-based resin composition in a mold, (2) heating the polyolefin-based resin composition in the mold under pressure (keeping of pressure) with a pressing machine or the like to decompose the crosslinking agent and foaming agent, and (3) ejecting a crosslinked foam from the mold after depressurization of the mold. In (2), time, temperature and pressure for heating under pressure can be properly determined depending on depth of the mold used, the crosslinking agent and foaming agent used, and the time is 1 to 1.5 minutes per depth of 1 mm inside the mold, the temperature is 150 to 170° C., and the pressure is 100 to 200 kg/cm³.

Further, in the pressure two-steps foaming method, the crosslinked foam is produced by (1) filling the polyolefin-based resin composition in a mold, (2) heating the polyolefin-based resin composition in the mold under pressure (keeping of pressure) with a pressing machine or the like to decompose a part of the crosslinking agent and foaming agent, (3) ejecting an intermediate crosslinked foam from the mold after depressurization of the mold, and (4) heating the intermediate crosslinked foam to decompose the residual crosslinking agent and foaming agent.

The metal charge to be charged inside a mold may be any metal charge if desired dimentions of depth, longitudinal and transverse inside the mold can be obtained, and at least one metal charge having a plate-like, frame-like or block-like shape is used, further, as material of the charge, at least one of iron, copper, zinc, brass, and aluminum is exemplified, and iron, copper and aluminum are preferable from the viewpoint of enhancing thermal conductivity.

Adjustment of dimensions inside the mold by the metal charge may be carried out by adjusting the dimensions inside the mold as to obtain a crosslinked foam having desired dimensions. For example, in a case of hₒ, depth inside the mold when a metal charge is not charged and Hₒ, height of a crosslinked foam obtained by pressure-foaming using the mold in which a metal charge is not charged, the depth of the mold is adjusted to hₐ from a proportional calculation shown by the below-described equation (1) so as to obtain a crosslinked foam having a height of Hₐ:
hₐ=hₒ×Hₐ/Hₒ (1)

Furthermore, for obtaining a crosslinked foam having desired dimensions of longitudinal and transverse, the dimensions inside the mold are also adjusted in the same manner as that in the above-described height.

In addition, the amount of the polyolefin-based resin composition to be filled in the mold is usually adjusted to the volume corresponding to the inside volume of the mold after a metal charge has been charged.

According to the process of the present invention in the production of a crosslinked foam of the polyolefin-based resin by a pressure-foaming method, for example, when a crosslinked foam which was larger than desired dimensions was obtained by changing a polyolefin-base resin composition as a raw material, a desired crosslinked foam in dimensions can be obtained without a production loss of a cut of f part caused to add a step of cutting off an excess part in a dimension to adjust the dimension of a crosslinked foam obtained to a desired dimension, or without preparation of molds depending on polyolefin-based resin compositions used as raw materials and change of a main body of the mold depending on change of the polyolefin-based resin compositions. Therefore, the production process is excellent in economic efficiency.

### EXAMPLE

The present invention will be illustrated in more detail by the following Examples.

[I] Physical property measuring method

(1) Melt Flow Rate (MFR, Unit: g/10 Minutes)

The MFR was measured by an A method under conditions of a temperature of 190° C. and a load of 21.18 N according to JIS K7210-1995.

(2) Density (Unit: kg/m³)

Annealing described in JIS K6760-1995 was carried out, then, the density was measured by an underwater substitution method described in JIS K7112-1980.

(3) Amount of Vinyl Acetate Units (Unit: % by Weight)

It was measured according to JIS K6730-1995.

(4) Thickness of Foam (Unit: mm)

A thickness of a crosslinked foam was measured after the crosslinked foam prepared by pressure-foam molding has been subjected to conditioning for 24 hours.

(5) Specific Gravity of Foam (Unit: kg/m³)

It was measured according to ASTM-D297.

(6) Expansion Ratio (Unit: Fold)

A volume of a resin composition before pressure-foam molding and a volume of a crosslinked foam after pressure-foam molding were measured, then the expansion ratio was determined by dividing the volume of the crosslinked foam after pressure-foam molding by the volume of the resin composition before pressure-foam molding.

### Reference Example 1

### Example 1

100 parts by weight of an ethylene-vinyl acetate copolymer (manufactured by The Polyolefin Company, Ltd., COSMOTHENE H2181 [MFR=2 g/10 minutes, density=940 kg/m³, vinyl acetate unit amount=18% by weight], hereinafter, referred to as EVA), 10 parts by weight of heavy calcium carbonate, 1 part by weight of stearic acid, 1.5 parts by weight of zinc oxide, 2.5 parts by weight of azodicarbonamide (Cellmic® CE manufactured by Sankyo Chemical Company, Ltd.) as a foaming agent and 1 part by weight of dicumyl peroxide were kneaded using a roll kneader under conditions of a roll temperature of 120° C. and a kneading period of 5 minutes to obtain a resin composition. 260 g of the resin composition was filled in a mold having inside dimensions of 15 cm×15 cm×10 mm, and pressure foamed under conditions of a temperature of 160° C., a time of 10 minutes and a pressure of 130 kg/cm² to obtain a crosslinked foam. Results of physical property evaluation of the crosslinked foam obtained were shown in Table 1.

### Example 1

80 parts by weight of an ethylene-α-olefin copolymer (Excellene GMH CB0002 [MFR=0.5 g/10 minutes, density=912 kg/m³](hereinafter, abbreviated as “PE”) manufactured by Sumitomo Chemical Company, Ltd.), 20 parts by weight of the ethylene-vinyl acetate copolymer, 10 parts by weight of heavy calcium carbonate, 1 part by weight of stearic acid, 1.5 parts by weight of zinc oxide, and 5.7 parts by weight of azodicarbonamide (Cellmic® CE manufactured by Sankyo Chemical Company, Ltd.) and 1 part by weight of dicumyl peroxide as a foaming agent, were kneaded using a roll kneader under conditions of a roll temperature of 120° C. and a kneading period of 5 minutes to obtain a resin composition.

An aluminum plate of 15 cm×15 cm×2 mm in dimensions was lined inside a mold having an inner dimension of 15 cm×15 cm×10 mm, 210 g of the resin composition was filled in the mold, and pressure foamed under conditions of a temperature of 160° C., a time of 8 minutes and a pressure of 130 kg/cm² to obtain a crosslinked foam. Results of physical property evaluation of the crosslinked foam obtained were shown in Table 1.

### Reference Example 2

A crosslinked foam was obtained in the same manner as in Example 1 except that the aluminum plate was not used, 260 g of the resin composition was filled in the mold and the pressure foaming time was 10 minutes. Results of physical property evaluation of the crosslinked foam obtained were shown in Table 1.

### Reference Example 3

A crosslinked foam was obtained in the same manner as in Example 1 except that the aluminum plate was not used, 210 g of the resin composition was filled in the mold and the pressure foaming time was 10 minutes. Asperity on the surface of the crosslinked foam obtained was very large, and numbers of rough and large cells were generated on the surface of the crosslinked foam. Therefore, a foamed molding having good properties could not be obtained.

TABLE 1

| | | | | | |
|---|---|---|---|---|---|
| | | Reference | | Reference | Reference |
| Item | Unit | Example 1 | Example 1 | Example 2 | Example 3 |

Resin composition

| | | | | | |
|---|---|---|---|---|---|
| PE | Part by | 0 | 80 | 80 | 80 |
| | weight | | | | |
| EVA | Part by | 100 | 20 | 20 | 20 |
| | weight | | | | |

Pressure-foaming condition

| | | | | | |
|---|---|---|---|---|---|
| Amount filled | g | 260 | 210 | 260 | 210 |
| Aluminum flat | | Not used | Used | Not used | Not used |
| plate | | | | | |

Physical properties of crosslinked foam

| | | | | | |
|---|---|---|---|---|---|
| Thickness | mm | 17 | 17 | 21 | — |
| Specific | kg/m³ | 4.9 | 9.1 | 9.1 | — |
| gravity | | | | | |
| Expansion | fold | 243 | 112 | 109 | — |
| Ratio | | | | | |

### EFFECT OF THE INVENTION

According to the present invention, a process for producing a polyolefin-based crosslinked foam by pressure foaming method in which the process is excellent in economic efficiency, can be provided.

1. A process for producing a crosslinked foam of a polyolefin-based resin by a pressure-foaming method, which comprises heating a polyolefin-based resin composition containing the polyolefin-based resin, a crosslinking agent and foaming agent under pressure using a mold in which a metal charge is charged inside the mold.

2. The process according to claim 1, wherein a material of the metal charge is a member selected from the group consisting of iron, copper, zinc, brass and aluminum.

3. The process according to claim 2, wherein the material of the metal charge is a member selected from the group consisting of iron, copper and aluminum.
